(19) United States
(12) Patent Application Publication
(10) Pub. No.: US 2014/0240230 A1
(43) Pub. Date: Aug. 28, 2014

(54) CONTROL METHOD FOR POINTER THROUGH TOUCHPAD

(71) Applicant: Hon Hai Precision Industry Co., Ltd., New Taipei (TW)

(72) Inventors: TING-AN LIU, New Taipei (TW); CHIN-SHUANG LIU, New Taipei (TW)

(73) Assignee: HON HAI PRECISION INDUSTRY CO., LTD., New Taipei (TW)

(21) Appl. No.: 14/161,667

(22) Filed: Jan. 22, 2014

(30) Foreign Application Priority Data
Feb. 26, 2013 (TW) 102106748

(51) Int. Cl. G06F 3/0354

(52) U.S. Cl. CPC G06F 3/03547
USPC 345/157

(57) ABSTRACT

An electronic device includes a touchpad and a display. The touchpad is divided into a central area and a lateral area. The lateral area surrounds the central area. A method for controlling a movement of a pointer across the display includes detecting a slide touch operation in the central area of the touchpad, moving the pointer across the display according to a direction of the slide touch operation, detecting a constant touch operation in the lateral area at an end point of the central area, and continuing to move the pointer across the display when the constant touch operation is detected.

### FIELD

The disclosed embodiments generally relate to a control method for a pointer through a touchpad.

### BACKGROUND

A touchpad is a pointing device equipped with a tactile sensor and a specialized surface that can translate a motion and position of a user's fingers on the touchpad into a relative motion and position of a pointer on a screen of an electronic device. However, because of limited sizes of the touchpads, continuous motions across the touchpad are hard to accomplish in one motion. Therefore, there is need for improvement within the art.

### BRIEF DESCRIPTION OF THE DRAWINGS

Many aspects of the embodiments within this disclosure can be better understood with reference to the following drawings. The components in the drawings are not necessarily drawn to scale, the emphasis instead being placed upon clearly illustrating the principles of the embodiments. Moreover, in the drawings, like reference numerals designate corresponding parts throughout the several views.

FIG. 1 is a block diagram of an embodiment of an electronic device.

FIG. 2 illustrates an example of an electronic device within this disclosure.

FIG. 3 illustrates an example of a touchpad of an electronic device within this disclosure.

FIG. 4 is similar to FIG. 2, but shows the touchpad of the electronic device in a state of use.

FIG. 5 is a flowchart of an embodiment of a control method for a pointer.

### DETAILED DESCRIPTION

The disclosure is illustrated by way of example, and not by way of limitation, in the figures of the accompanying drawings in which like references indicate similar elements. It should be noted that references to “an” or “one” embodiment in this disclosure are not necessarily to the same embodiment, and such references mean “at least one.”

In general, the word “module”, as used herein, refers to logic embodied in hardware or firmware, or to a collection of software instructions, written in a programming language, such as, Java, C, or assembly. One or more software instructions in the modules may be embedded in firmware, such as EPROM. The modules described herein may be implemented as either software and/or hardware modules and may be stored in any type of non-transitory computer-readable medium or other storage device. Some non-limiting examples of non-transitory computer-readable media include CDs, DVDs, BLU-RAY, flash memory, and hard disk drives.

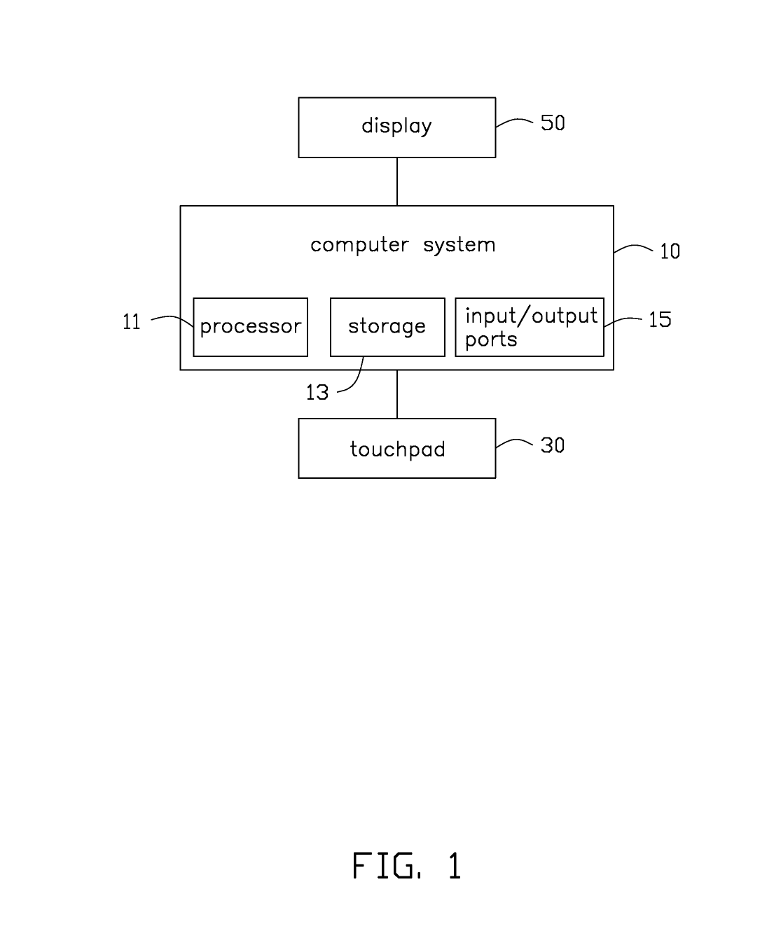

FIG. 1 is a block diagram of an embodiment of an electronic device. The electronic device can be, without limitation, a laptop computer, a smart phone, or a desktop computer. The electronic device includes a computer system 10, a touchpad 30, and a display 50. The computer system 10 is electrically connected to the touchpad 30 and the display 50. The computer system 10 includes a processor 11, a storage 13, and a plurality of input/output ports 15. The computer system 10 controls a pointer shown on the display 50 to move across the display 50.

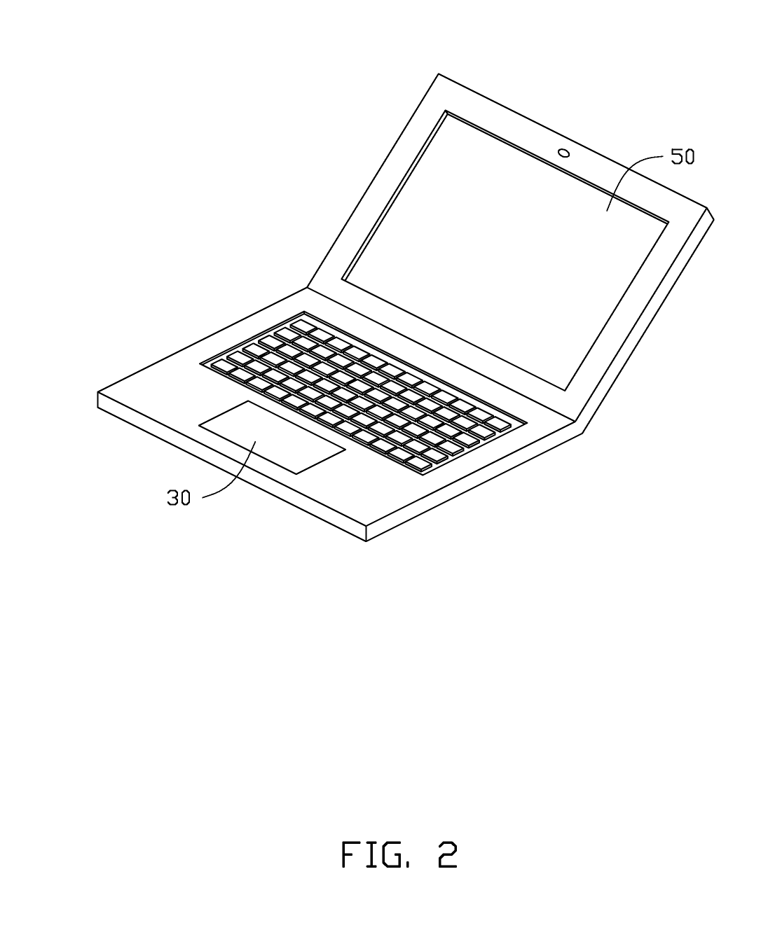

FIG. 2 illustrates one embodiment of an electronic device. The touchpad 30 of this disclosure can be substantially rectangular and made of carbon nanotubes.

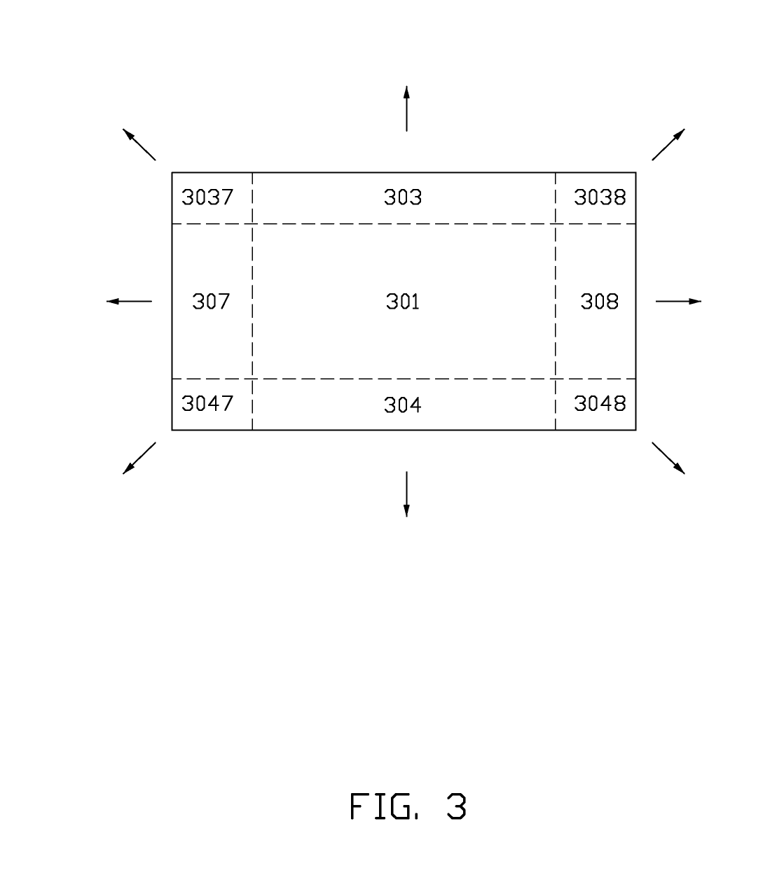

FIG. 3 illustrates a schematic view of the touchpad 30. The touchpad 30 includes a central area 301 and a lateral area (not labeled) surrounding the central area 301. The lateral area is divided into a top area 303, a bottom area 304, a left area 307, a right area 308, a top-left area 3073, a bottom-left area 3047, a top-right area 3038, and a bottom-right area 3048. The top-left area 3037, the left-bottom area 3047, the top-right area 3038, and the bottom-right area 3048 correspond to four respective corners of the touchpad 30.

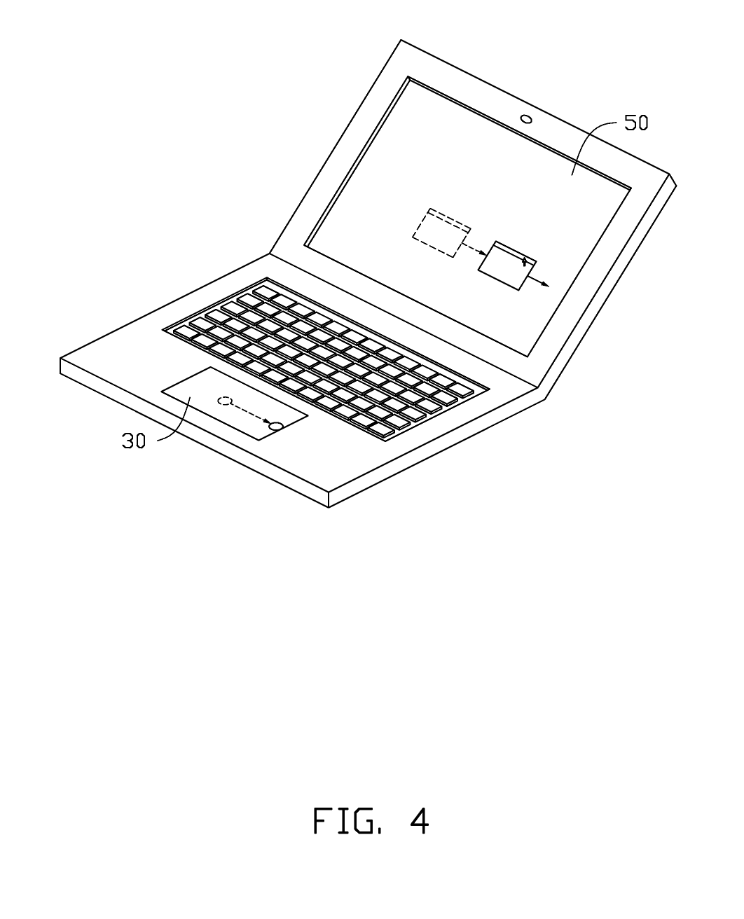

FIG. 4 shows the touchpad 30 controlling a pointer displayed on the display 50 in response to a user input. In one embodiment, to drag a window or a widget displayed on the display 50, the processor 11 detects a sliding touch operation on the touchpad 30, and the computer system 10 moves the pointer across the display 50 according to a direction of the sliding touch operation. When the slide touch operation reaches the lateral area and the pointer does not reach an edge of the display 50, when the processor 11 detects a constant touch operation in the lateral area, the pointer continues to move in the same direction across the display 50. For example, when the constant touch operation is located in the left area 307, the pointer continues to move left. When the constant touch operation is located in the right area 308, the pointer continues to move right. When the constant touch operation is located in the top area 303, the pointer continues to move up. When the constant touch operation is located in the bottom area 304, the pointer continues to move down.

Furthermore, when the constant touch operation is located in the corner areas, the computer system 10 moves the pointer along a corresponding diagonal direction.

In one embodiment, to execute a dragging operation on the display 50, the processor 11 further detects a slide motion starting from the lateral area and sliding to the central area 301. The computer system 10 moves the pointer according to the direction of the slide motion. The computer system 10 stops moving the pointer when no contact operation is detected on the touchpad 30. The computer system 10 moves the pointer at a speed relative to a speed of the slide touch operation.

In one embodiment, to distinguish the lateral area from the central area 301, the lateral area and the central area 301 are made of different materials or tactically different.

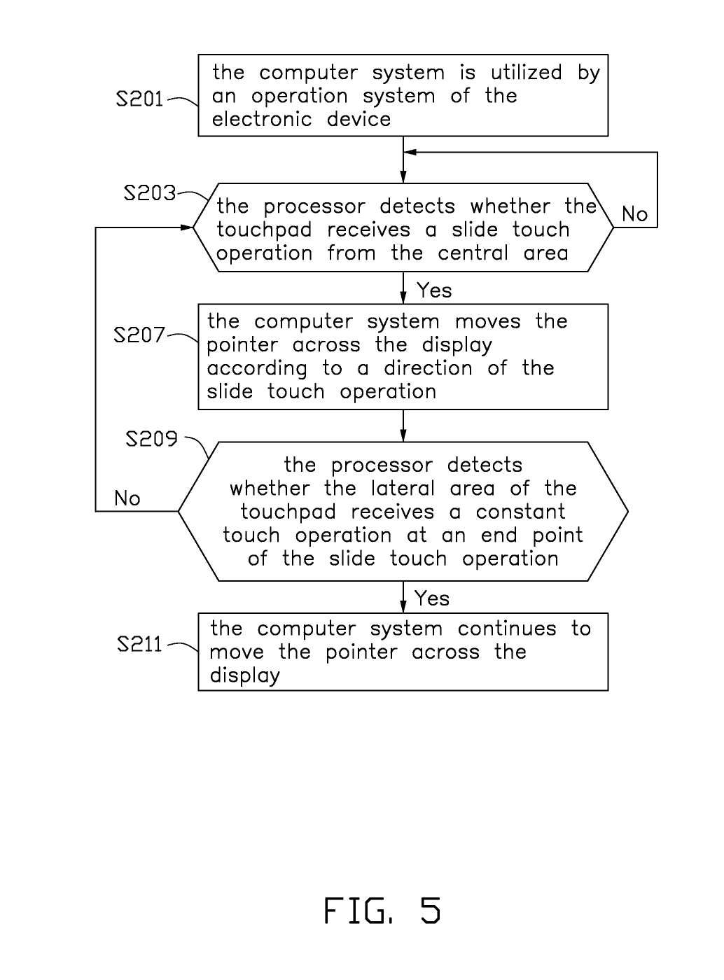

FIG. 5 illustrates a flowchart of an embodiment of a control method for a pointer. The control method for the pointer includes the following steps.

Step S201: the computer system 10 is utilized by an operation system of the electronic device.

Step S203: the processor 11 detects whether the touchpad 30 receives a slide touch operation from the central area 301. If not, step S203 is repeated. If yes, the process goes to step S207.

Step S207: the computer system 10 moves the pointer across the display 50 according to a direction of the slide touch operation.

Step S209: the processor 11 detects whether the lateral area of the touchpad 30 receives a constant touch operation at an end point of the slide touch operation when the pointer has not reaches an edge of the display 50. If not, the process goes to step S203. If yes, the process goes to step S211.

Step S211: the computer system 10 continues to move the pointer across the display 50. The pointer may be moved at a constant speed.

It is to be understood that even though numerous characteristics and advantages have been set forth in the foregoing description of embodiments, together with details of the structures and functions of the embodiments, the disclosure is illustrative only and changes may be made in detail, especially in matters of shape, size, and arrangement of parts within the principles of the disclosure to the full extent indicated by the broad general meaning of the terms in which the appended claims are expressed.

Depending on the embodiment, certain steps or methods described may be removed, others may be added, and the sequence of steps may be altered. It is also to be understood that the description and the claims drawn for or in relation to a method may include some indication in reference to certain steps. However, any indication used is only to be viewed for identification purposes and not as a suggestion as to an order for the steps.

What is claimed is:

1. A control method for a pointer by a touchpad, the touchpad defining a central area and a lateral area, the lateral area located on a lateral side of the central area, the control method comprising:
detecting a slide touch operation;
moving the pointer across a display according to a direction of the slide touch operation;
detecting a constant touch operation on the lateral area at an end point of the slide touch operation; and
moving the pointer across the display.

2. The control method of claim 1, wherein the pointer executes a dragging operation.

3. The control method of claim 1, wherein the lateral area defines a top area and a bottom area, when the constant touch operation is located in the top area, the pointer moves up, and when the constant touch operation is located in the bottom area, the pointer moves down.

4. The control method of claim 3, wherein the lateral area further defines a left area and a right area, when the constant touch operation is located in the left area, the pointer moves left, and when the constant touch operation is located in the right area, the pointer moves right.

5. The control method of claim 4, wherein the lateral area further defines four corner areas, when the constant touch operation is located in the corner areas, the pointer moves along a corresponding diagonal direction.

6. The control method of claim 1, wherein the central area and the lateral area are made of different materials.

7. The control method of claim 1, wherein moving the pointer further comprises: moving the pointer at a constant speed.

8. The control method of claim 1, further comprising: detecting a slide motion from the lateral area to the central area after the constant touch operation; and moving the pointer according to the slide touch operation.

9. The control method of claim 1, further comprising: stop moving the pointer when on contact is detected.

10. The control method of claim 1, wherein the lateral area and the central area are tactically different.

11. A control method comprising:
providing a touchpad to control a pointer on a display;
defining a central area and a lateral area in the touchpad, wherein the lateral area located on a lateral side of the central area;
detecting a slide touch operation on the touchpad;
moving the pointer across the display according to a direction of the slide touch operation;
detecting a constant touch operation on the lateral area at an end of the slide touch operation; and
moving the pointer across the display.

12. The control method of claim 11, wherein the pointer executes a dragging operation.

13. The control method of claim 11, wherein the lateral area defines a top area and a bottom area, when the constant touch operation is located in the top area, the pointer moves up, and when the constant touch operation is located in the bottom area, the pointer moves down.

14. The control method of claim 13, wherein the lateral area further defines a left area and a right area, when the constant touch operation is located in the left area, the pointer moves left, and when the constant touch operation is located in the right area, the pointer moves right.

15. The control method of claim 14, wherein the lateral area further defines four corner areas, when the constant touch operation is located in the corner areas, the pointer moves along a corresponding diagonal direction.

16. The control method of claim 11, wherein the central area and the lateral area are made of different materials.

17. The control method of claim 11, wherein moving the pointer further comprises: moving the pointer at a constant speed.

18. The control method of claim 11, further comprising: detecting a slide motion from the lateral area to the central area after the constant touch operation; and moving the pointer according to the slide motion.

19. The control method of claim 11, further comprising: stop moving the pointer when on contact is detected on the touchpad.

20. The control method of claim 11, wherein the lateral area and the central area have different tactile sensations.
